(19) United States
(12) Patent Application Publication
(10) Pub. No.: US 2011/0270665 A1
(43) Pub. Date: Nov. 3, 2011

(54) Expiring Virtual Gift Card Statement Credit Exchange for Loyalty Reward

(75) Inventors: Nancy Kim, San Francisco, CA (US); Diane C. Salmon, Lafayette, CA (US)

(73) Assignee: VISA U.S.A., San Francisco, CA (US)

(21) Appl. No.: 13/098,371

(22) Filed: Apr. 29, 2011

Related U.S. Application Data
(60) Provisional application No. 61/329,377, filed on Apr. 29, 2010.

(51) Int. Cl. G06Q 30/00

(52) U.S. Cl. 705/14.33

(57) ABSTRACT

A statement credit reward system receives a request to redeem reward points from an account holder in exchange for a virtual gift card, where the account holder's request may be in response to an offer from a merchant for the card. The statement credit reward system receives transaction information corresponding to one or more transactions conducted by the account holder with one or more merchants. The transaction information may contain a qualifying transaction conducted by the account holder with a merchant. The statement credit reward system will attempt to match a statement credit trigger with the qualifying transaction. If a match is not found, the statement credit reward system adds the predetermined number of reward points back into the account holder's balance of reward points. If a match is found, the statement credit reward system credits the monetary amount of the statement credit trigger to the account holder's balance.

### RELATED APPLICATION

The present application is a non-provisional application which claims the benefit of U.S. Provisional Application Ser. No. 61/329,377, filed Apr. 29, 2010 entitled “EXPIRING VIRTUAL GIFT CARD STATEMENT CREDIT EXCHANGE FOR LOYALTY REWARD,” the entire contents of which are incorporated by reference as if fully set forth herein.

### COPYRIGHT NOTICE AND PERMISSION

A portion of the disclosure of this patent document contains material which is subject to copyright protection. The copyright owner has no objection to the facsimile reproduction by anyone of the patent document or the patent disclosure, as it appears in the patent and trademark office patent file or records, but otherwise reserves all copyright rights whatsoever.

### FIELD

Implementations generally relate to systems for rewarding account holders for commercial loyalty, and more particularly to the account holders redeeming a reward currency for financial currency selected by the account holders.

### BACKGROUND

Card issuers often provide incentives to card holders to use issued credit cards. The incentives often lead to increased card usage, both in terms of frequency and currency volume, ultimately leading to increased revenue to the card issuer and transaction handler. Among account holders who possess multiple credit cards, incentives may also result in the preferential use of one card over all others.

Incentives come in the form of a benefit to the account holder. The benefit may be in the form of direct rewards, such as frequent flyer miles, “cash back” rewards, or statement credits. Direct rewards are realized by the account holder by providing the account holder with a refund of money or providing direct savings on a future transaction.

Another common incentive that can be used to provide a direct reward is the issuance of a gift card to a loyalty account holder. Gift cards have a stated value and can be used by the account holder as a cash equivalent when making purchases. Gift cards are typically valid for a narrow range of transactions. For example, a $50 gift card may be used for a purchase with a particular merchant or for a particular product. While gift cards provide account holders the benefit of saving on qualified purchases, the limited nature of gift cards, because they are valid for a narrow range of transactions, may lessen their effectiveness and desirability to account holders.

One common incentive providing an indirect benefit is reward points. Reward points are earned by the account holder through use of the card and accumulate over time. Reward points are a type of indirect reward because they cannot be directly used by the account holder, but are instead redeemed for a gift card, frequent flyer miles, or other direct reward. The account holder may redeem the reward points after a sufficient number have accumulated. The card issuer typically provides the account holder a catalog of redemption options.

Reward points are beneficial to account holders because they give the account holder a wide range of redemption options. Instead of locking the account holder into a certain type of reward, reward points allow the account holder to receive different direct rewards over time. In addition, reward points allow the account holder to simultaneously split reward points between multiple redemption options. Card issuers also benefit from using indirect rewards, such as reward points, over direct rewards. Using reward points, card issuers need not anticipate the type of direct reward the account holder may want nor do they need to lock the account holder into one specific direct reward plan. In addition, card issuers can change the direct rewards available for redemption by account holders at any time.

An especially effective incentive scheme involves combining reward points with gift cards. Card issuers may include gift cards from many different merchants or manufacturers in the array of available redemption options. Faced with these redemption options, account holders can choose the gift card that they find most valuable. For example, an account holder may choose a gift card from a store that they frequently patronize. This arrangement maximizes value to the account holder and therefore the account holder's loyalty to the card issuer and transaction handler.

Once reward points are redeemed for a gift card, the gift card is delivered to the account holder. The card issuer incurs a cost in processing and delivering the gift card to the account holder. This includes the cost of the envelope, postage, manufacturing the gift card itself, and any explanatory documents included with the gift card. This cost may preclude smaller card issuers from offering gift cards. In addition, the cost may preclude gift cards with a smaller geographic scope, such as local or regional gift cards or gift cards targeting a certain product.

Additionally, every gift card redeemed requires a separate card, a separate envelope, and a separate explanatory letter. A substantial number of gift card redemptions may result in significant consumption of paper and plastic resources.

Once a customer redeems earned reward points for a particular gift card, such as a gift card for a particular merchant, the customer is typically locked into the gift card and cannot convert the gift card back into reward points or exchange the gift card for another gift card, such as a gift card for a different merchant. This rigidity occasionally results in an account holder failing to use the gift card because the customer may no longer have a need to patronize the store or purchase the product that is the target of the gift card. When an account holder fails to receive the benefit, the effect of the incentive is diminished.

Similarly, if a gift card obtained through redeemed reward points is never used by the account holder, the value attached to the gift card remains locked, unused, on the gift card indefinitely. Or, in some cases, the gift card will eventually expire. In either case, the account holder fails to receive the value of the benefit.

From the standpoint of the card issuer and merchant, the current system of providing gift cards through redeemed reward points limits the scope of the incentive to relatively large merchants or manufacturers. As previously mentioned, the cost of creating a gift card, which includes the cost of the card, the postage, and the accompanied informational letter, requires gift cards to have broad appeal to be cost effective—for example, by providing discounts for large merchants or for nationally available, brand name products. Gift cards on a smaller scale, such as for a particular product or for a small regional or local merchant, are cost prohibitive. Most merchants, aside from perhaps the largest, are therefore excluded from being included in such an incentive program.

The reward process itself is sometimes inconvenient for account holders. The account holder cannot use the gift card immediately upon redemption. Once reward points are redeemed, the account holder waits to receive the card in the mail before it can be used. In addition, the gift card is presented at the time of a qualified purchase, requiring the account holder to be in possession of the card at that time. Similarly, while the account holder may make a qualified purchase with intent to use a gift card, the account holder must remember to present the card at the time of the qualified purchase. If the account holder fails to receive the benefit of the gift card for any of the above-mentioned reasons, the effect of the incentive is diminished.

The reward process can also be inconvenient for merchants. Merchants must properly handle the transaction at the point of sale (POS) in order for the account holder to receive the benefit of the gift card. For example, if an account holder presents a $50 gift card during a transaction to purchase a $100 item, the merchant must process the $50 gift card before charging the remainder to the account holder's credit card. Merchants must therefore train their employees on how to handle gift cards in split tender transactions.

The array of practical redemption options for a gift card obtained through redeemed reward points is limited because the gift card is physically delivered to the account holder after redemption. As a result, other more expedient redemption options, such as cell phone, Personal Digital Assistant (PDA), or any other mobile Internet connected device, do not add significant value because the account holder still waits for the gift card to be delivered before the gift card can be used.

Accordingly, it would be desirable to have an incentive system to spur credit card usage that costs less to administer, provides increased flexibility in redemption options for the card issuer, merchants, and account holders, is more environmentally friendly, and provides the account holder with a quickly realized benefit.

These and other objects of the present invention will become clear to those skilled in the art in view of the description of the best presently known mode of carrying out the invention and the industrial applicability of the preferred embodiment as described herein.

### SUMMARY

In one implementation, an account holder has been issued financial and non-financial currency accounts by one or more issuers. The account holder can use a balance of a non-financial currency in the non-financial currency account to conduct a qualifying transaction with a merchant by requesting a virtual gift card that can be so used with the merchant. A virtual gift card includes a data entry indicating the applicable statement credits with associated qualifying conditions and expiration date. Upon receiving the request from the account holder to redeem reward points from the non-financial currency account that was issued by an issuer to the account holder, in exchange for a virtual gift card, a deduction will be made of a predetermined number of reward points from account holder's balance of reward points in the non-financial currency account. A statement credit trigger will also be created.

The statement credit trigger corresponds to: (i) a monetary amount available for the account holder to conduct the qualifying transaction with the merchant, and (ii) the predetermined number of reward points deducted from the non-financial currency account. Thereafter, a virtual gift card processing entity will receive transaction information, wherein the transaction information may contain the qualifying transaction conducted by the account holder with the merchant. The virtual gift card processing entity will attempt to find a match of the statement credit trigger with the qualifying transaction in the received transaction information. If the match is not found, then the account holder will be deemed not to have used the virtual gift card to conduct the qualifying transaction with merchant. As such, the statement credit trigger will be deleted and the predetermined number of reward points will be added back to account holder's balance of reward points in the non-financial currency account. If, however, the match is found, then the account holder will be deemed have used the virtual gift card to conduct the qualifying transaction with merchant. As such, the monetary amount corresponding to the statement credit trigger will be credited as a statement credit to the financial currency account that was issued to the account holder. Note that the qualifying transaction that was conducted by the account holder with the merchant can be for a good and/or service that was distributed to the merchant by a distributor and manufactured by a manufacturer. As such, the virtual gift can be sponsored by, and thus paid for as an assessment, by the merchant, the manufacturer, the distributor, or a combination of these.

In yet another implementation, a request is received to redeem reward points from an account holder in exchange for a virtual gift card. Then a predetermined number of reward points are deducted from the account holder's balance of reward points, whereupon a statement credit trigger is created. Upon receiving transaction information, which may include a qualifying transaction, an attempt is made to match the statement credit trigger with the qualifying transaction. Upon finding a match, the statement credit trigger is deleted or modified and the predetermined number of reward points is added to account holder's balance of reward points. Upon not finding a match, the monetary amount of the statement credit trigger is credited to the account holder.

### BRIEF DESCRIPTION OF THE DRAWINGS

The embodiments are illustrated by way of example and not limitation in the figures of the accompanying drawings in which like references indicate similar elements.

FIG. 1 depicts a block diagram illustrating the functional blocks of one embodiment of the present invention. Each block performs a function and does not necessarily represent a physical item;

FIG. 2 is a flowchart illustrating an exemplary process to redeem reward points and process the corresponding statement credits;

FIGS. 3(a) and 3(b) are exploded views of display screens featuring exemplary screen shots for rendering on one or more display devices;

FIG. 4 illustrates an exemplary payments processing system for processing transactions conducted with merchants by account holders thereof, wherein, for each transaction, there is a provision of a service or good by a merchant to an account holder, there is an authorizing and remunerating of an electronic payment by the account holder in conducting the transaction with the merchant, and there is a authorizing and remunerating of an electronic payment by the merchant in fulfilling the statement credit to the account holder;

FIG. 5 illustrates various components housed within an interchange center to provide online and offline transaction processing for transactions conducted upon accounts issued by issuers to account holders, where the transaction are conducted with merchants by use the payments processing system of FIG. 4; and

FIG. 6 illustrates another view of the components of FIG. 5.

FIG. 7 is a diagram of a computer hardware architecture compatible with the present system and method.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein are merely provided for ease of reference, and shall not be interpreted in any way to limit this disclosure or the following claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

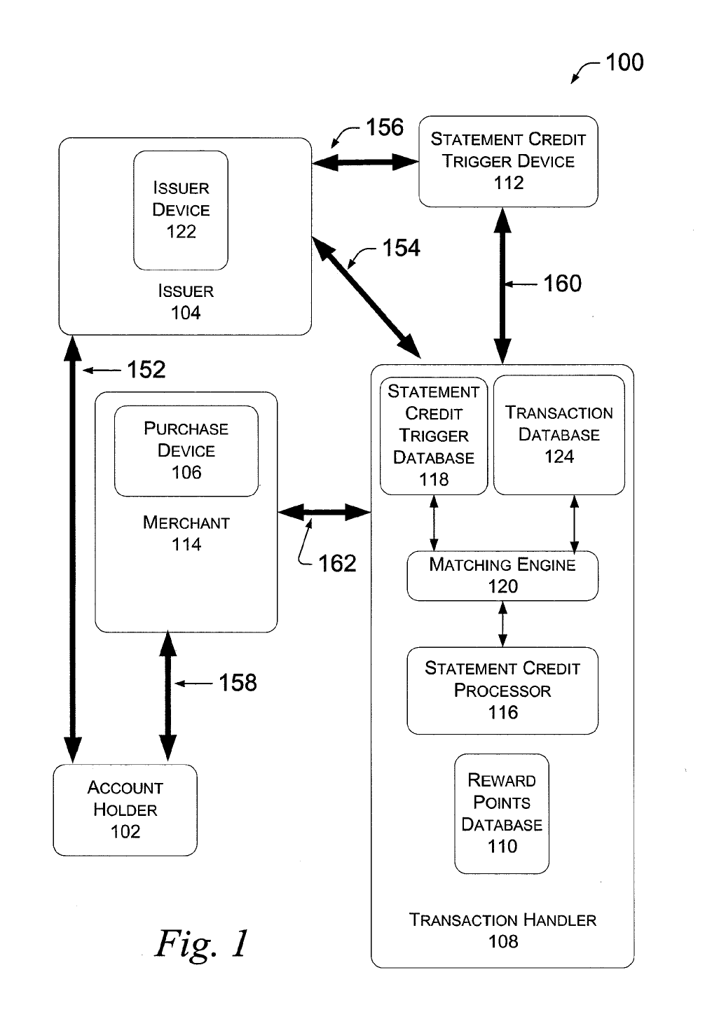

Referring to FIG. 1, a block diagram 100 illustrating the functional blocks of one embodiment of the present invention, an account holder 102 accumulates reward points, or other non-financial currency, by making purchases on a credit card issued by issuer 104. Of course, debit and prepaid cards can also be used to accumulate reward points. In one embodiment, once a sufficient number of reward points are accumulated, account holder 102 redeems reward points for a virtual gift card as indicated by arrow 152.

Upon redemption of the reward points by the account holder 102, the issuer 104, using issuer device 122, contacts transaction handler 108, as indicated by arrow 154, to deduct the appropriate number of reward points from the account holder's balance of rewards points in reward points database 110.

A statement credit is an amount credited back to the account holder's credit card statement. For example, for an account holder having an initial credit balance of $1000, a $100 statement credit would result in a new credit balance of $900. The $100 credit would appear on the account holder's statement (i.e. the account holder would not receive a separate check or other representation of the credit) and is therefore referred to as a statement credit.

Concurrently, or within a short time of deducting the account holder's reward points from the reward points database 110, the issuer 104 creates a statement credit trigger using statement credit trigger device 112 as indicated by arrow 156. The statement credit trigger device 112 adds the statement credit trigger to the statement credit trigger database 118 by contacting transaction handler 108 as indicated by arrow 160. In one embodiment, the statement credit trigger contains the attributes of a qualifying transaction, which is a transaction that is executed by the account holder in order to trigger an actual statement credit. For example, a given statement credit trigger may define a qualifying transaction as a purchase in excess of $50 at a particular hardware store. A transaction for under $50 at the particular hardware store, or over $50 at a different hardware store, will not be considered a qualifying purchase and therefore not trigger the statement credit.

In one embodiment, each statement credit trigger will also contain an expiration period or date. For example, the statement credit trigger may be valid for 30 days or until January 1. The account holder makes a qualifying purchase before the statement credit trigger expires to receive the actual statement credit.

Purchases made by account holder 102 from merchant 114, as indicated by arrow 158, are processed by the transaction handler 108. The transaction details are added to transaction database 124, as indicated by arrow 162.

A matching engine 120 monitors the transaction database 124 and the statement credit trigger database 118. The matching engine 120 attempts to find a transaction in the transaction database 124 that satisfies the requirements of a qualifying transaction as defined by a statement credit trigger. If the matching engine 120 successfully identifies a transaction that fulfills the requirements of a qualifying transaction, the matching engine contacts the statement credit processor 116.

The statement credit processor 116 processes the statement credit, which results in a credit to the account holder's account in the amount of the statement credit. The statement credit processor 116 also collects the amount of the statement credit from the issuer 104. The net result is a transfer of funds from the issuer 104 to the account holder 102 in the amount of the statement credit.

In one embodiment, the matching engine 120 monitors the transaction database 124 and the statement credit trigger database 118 for partial use of the virtual gift card. So when the account holder fulfills a qualifying transaction that uses part of the statement credit associated with the virtual gift card, the matching engine contacts the statement credit processor 116 with part of the statement credit. An example of this type of transaction would be when an account holder may have more in the virtual card than required for the transaction. In which case, the matching engine again determines that there is a remaining balance in the virtual gift card after the processing of the qualifying transaction and contacts the statement credit processor with the appropriate amount to be applied to the statement credit.

In one embodiment, upon finding a match between an entry in the statement credit trigger database and the transaction database, the statement credit trigger is deleted. In another embodiment, upon finding a match, a determination is made whether the statement credit trigger should be deleted or modified. If a determination is made to modify the statement credit trigger (as in the case of a partial use of the virtual gift card), information regarding the reward points and qualifying conditions is passed to the statement credit trigger device 112 which creates a replacement statement credit trigger which is incorporated into the statement credit trigger database. In one embodiment, the matching engine, or the statement credit processor, may modify the statement credit trigger directly.

In one embodiment, the matching engine 120 also monitors the statement credit trigger database 118 for expired statement credit triggers. If the matching engine 120 encounters an expired statement credit trigger, the matching engine 120 deletes the expired statement credit trigger. In addition, the matching engine increments the value of the reward points associated with account holder in the reward point database 110. The reward points are incremented by the same number as was deducted when the reward points were originally redeemed by account holder, although an equivalent of a handling fee can optionally be assessed in reward points or other non-financial currency as an overhead expense for failing to conduct the qualifying transaction prior to expiration of the virtual gift card.

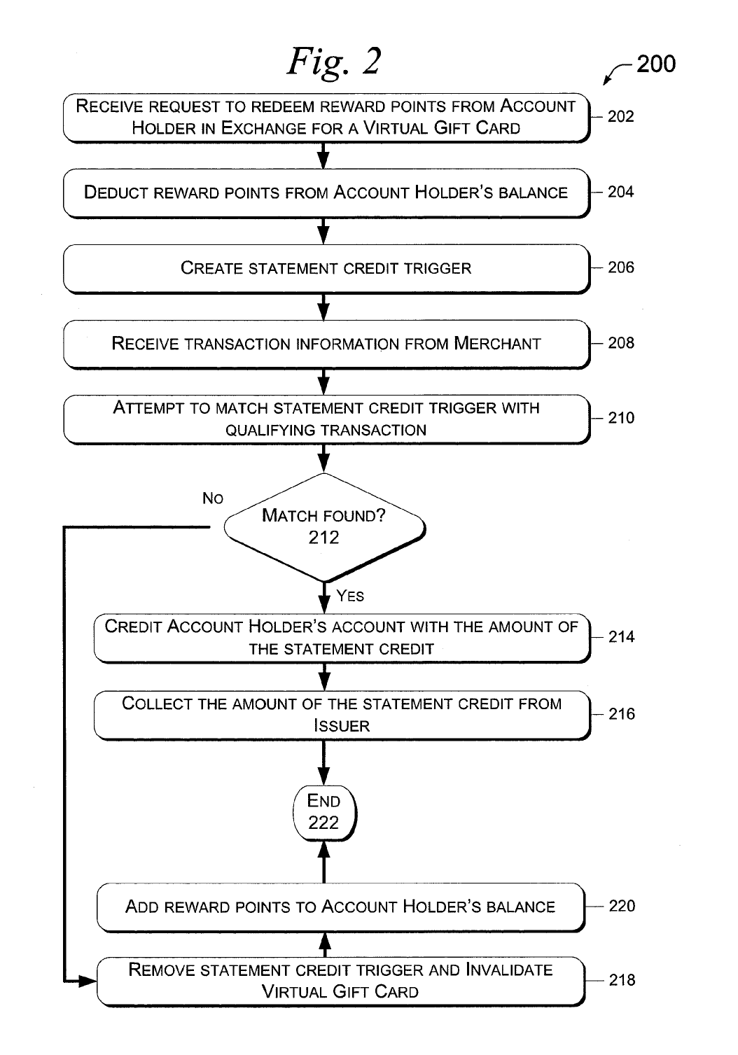

FIG. 2 contains a flowchart illustrating an exemplary process 200 for redeeming reward points and processing statement credits. A request is received to redeem reward points from the account holder at step 202. In one embodiment, the account holder, after earning a sufficient number of reward points, browses the available redemption options. The account holder then redeems a number of earned reward points for a virtual gift card. The account holder redeems the reward points using a redemption device such as a desktop computer, laptop computer, notebook computer, tablet computer, cellular telephone, PDA, network enabled television set or other internet connected device.

A virtual gift card may be used for a qualifying transaction. For example, a $50 virtual gift card for a particular hardware store may not apply to purchases under $50 at the particular hardware store or for purchases of any amount at other hardware stores. A virtual gift card, unlike a traditional gift card, exists in electronic form. A virtual gift card has a currency value that can be applied to a qualified purchase. In the present embodiment, one of the primary purposes of the virtual gift card is to provide the account holder with a representation of their redeemed reward points. Also, in the present embodiment, the virtual gift card is treated as a statement credit. Upon making a qualifying transaction, the full price of the transaction is charged to the account holder, then the account holder's account is credited back the amount of the virtual gift card as a statement credit.

In this sense, a virtual gift card differs from a traditional gift card. With a traditional gift card, the amount of the transaction is deducted from the gift card at the time of the transaction at the Point of Service terminal (POS) such that account holder is charged the retail price less the amount deducted from the gift card. A virtual gift card includes a data entry in the statement credit trigger database such that if the account holder makes one or more qualifying purchases, the qualifying transactions will be automatically detected by the matching engine 120 of the transaction handler 108, and a statement credit applied. Thus, the virtual gift card is embodied in the data entry (e.g., a statement credit trigger within the statement credit trigger database) that identifies the amount of statement credit available, the qualifying conditions (e.g., the expiration date, the identity of the merchant from which the virtual gift card/statement credit can be redeemed, etc.) The data entry controls the statement credit processor 116 to create a statement credit to the account holder's account in response to qualifying transactions.

After the account holder selects a virtual gift card and redeems the reward points for the selected virtual gift card, the reward points are deducted from the account holder's balance of reward points at step 204.

Next, a statement credit trigger is created at step 206. In the present embodiment, the statement credit trigger contains the requirements for a qualifying transaction, including an identifier for a specific merchant, a currency amount which can be specified to be a minimum currency amount of a transaction with the merchant, and expiration information which may be a date by which the transaction with the merchant is conducted in order to be valid. The statement credit triggers are stored in a statement credit database.

Transaction information for an account holder is received from merchants at step 208. Transactions relating to the account holder's account for respective merchants are received, including those for non-qualifying transactions that are unrelated to the statement credit trigger. The transaction information is stored in a transaction database.

The statement credit trigger database and the transaction database are monitored in an attempt to find qualifying transactions (i.e. transactions in the transaction database that meet the requirements for a qualifying transaction as defined by a statement credit trigger) at step 210.

If a qualifying transaction is found in the transaction database at step 212, a statement credit is applied to account holder's account in the amount of the virtual gift card at step 214. A corresponding amount is also collected from the issuer at step 216 to make up for the amount of the statement credit. The net result of the statement credit to the account holder and the reimbursement of funds from the issuer is a transfer of funds from the issuer to the account holder. In another embodiment, the reimbursement may be funded by one or a combination of entities, including a merchant, manufacturer, or issuer. Finally, the process ends at step 222.

If a qualifying transaction is not found in the transaction database before the expiration of a statement credit trigger at step 212, the statement credit trigger is removed from the statement credit trigger database at step 218. Removing the statement credit trigger from the statement credit trigger database results in an invalidation of the virtual gift card. Next, reward points corresponding to the virtual gift card currency amount are added back to the account holder's balance of reward points at step 220. Thus, the number of reward points added back is equivalent to the number initially redeemed, although an equivalent of a handling fee can optionally be assessed in reward points or other nonfinancial currency as an overhead expense for failing to conduct the qualifying transaction prior to expiration of the virtual gift card. In one embodiment, the account holder will receive an electronic communication that the virtual gift card has been invalidated and that the redeemed reward points have been added back to the account holder's reward point balance. Finally, the process ends at step 222.

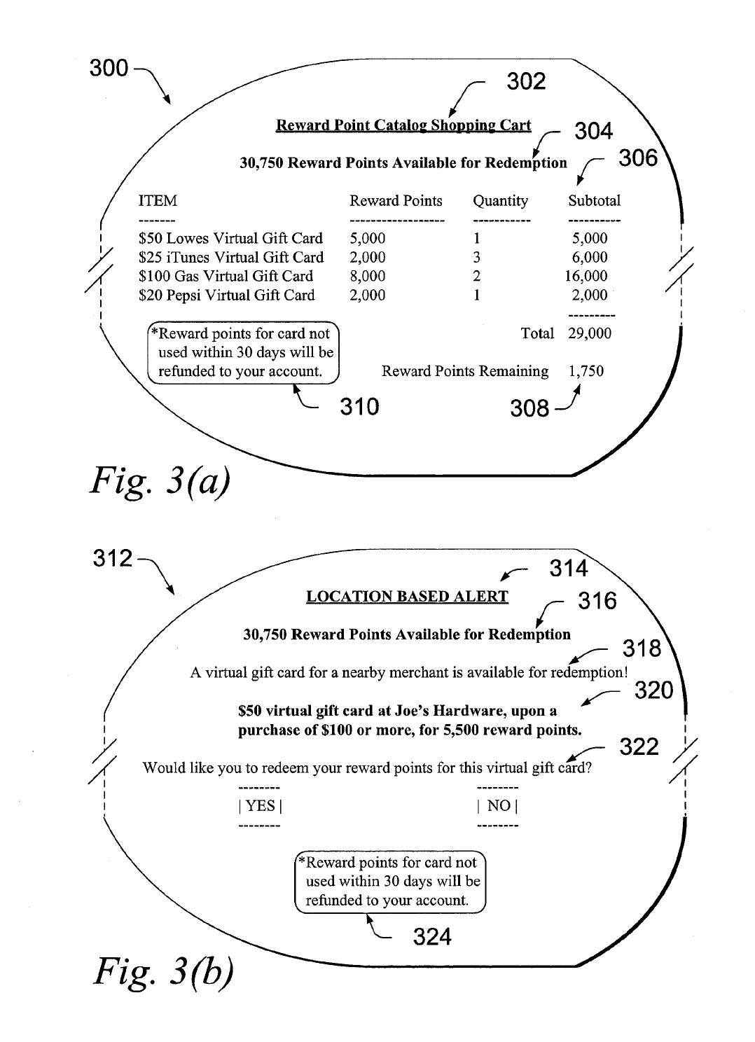

By way of example, FIG. 3(a) depicts a display screen 300, in the exploded view thereof. Display screen 300 features a screenshot as viewed by an account holder. Using display screen 300, an account holder can redeem reward points for one or more virtual gift certificates. The display screen 300 may be displayed on a personal computer, laptop or notebook computer, a cell phone, PDA, or any other Internet connected or web enabled mobile computing device.

Display Screen 300 contains an example catalog shopping cart 302. The account holder browses the reward point redemption catalog and selects the desired items for redemption, which are then added to the catalog shopping cart 302. The catalog shopping cart 302 contains an inventory 306 of the contents of the shopping cart 302, including the item name, the reward points required for redemption, the quantity, the subtotal, and the total number of reward points necessary to redeem the selected items.

In the present embodiment, the catalog shopping cart also contains the total number of reward points available for redemption 304 and the total number of reward points remaining 308 after the selected items in the catalog shopping cart 302 are redeemed.

The Shopping Cart 302 also contains a notice 310 stating the period in which the virtual gift cards are valid. The notice 310 also declares that if any virtual gift cards expire without being used, reward points will be refunded to the account holder's balance in a number equivalent to the reward points used to redeem the virtual gift card. In an example of the present embodiment, virtual gift cards have the same validity period of 30 days after the virtual gift card is issued. In another embodiment, each virtual gift card may have a different validity period and/or a virtual gift card may have an expiration date that is independent of issue date, such as virtual gift cards that expire on January 5, regardless of when the virtual gift card was issued.

By way of example, FIG. 3(b) depicts a display screen 312, in the exploded view thereof. Display screen 312 features a screenshot as viewed by an account holder. Using display screen 312, an account holder can be notified of available redemption options using location based services and can be given an opportunity to act on the redemption options. Location based services make it possible to determine the geographic location of a mobile device. In one embodiment, an account holder may receive an alert consisting of available redemption options that can be used with a merchant that is in the same physical vicinity of the account holder's mobile computing device. The alert may be in the form of a text message, an application alert, or any other alert that is likely to draw the attention of the account holder. In one embodiment, the alert may be in the form of display screen 312.

When the account holder, possessing a mobile device equipped with location based services, comes within physical proximity to a merchant that has an associated virtual gift card, the account holder will receive an alert on their mobile device. The display screen 312 is an example of the display on the mobile device. Display screen 312 contains a location based alert message 314. The location based alert message contains the total number of reward points that the account holder has available for redemption 316. The location based alert 314 contains a generic message 318 stating that a virtual gift card for a nearby merchant is available for redemption and contains a specific message 320 describing the specifics of the available virtual gift card. In another embodiment, the location based alert message may also contain the address of the merchant and a map with directions to the merchant

The location based alert 314 also enables the account holder the ability to instantly redeem their reward points for the identified virtual gift card at 322. If the account holder selects “no”, choosing not to redeem their reward points for the identified virtual gift card, no further action is taken.

If, on the other hand, the account holder selects “yes” to redeem their reward points for the identified gift card, a statement credit trigger is created and the balance of account holder's reward points are reduced by the appropriate number, in this case 5,500 as seen in 320. Account holder may make a qualifying purchase, in this case a purchase of $100 or more at Joe's Hardware at 320, and receive the benefit of the $50 statement credit.

The location based alert 314 also contains a notice 324 stating the period in which the virtual gift cards are valid. The notice 324 also declares that if any virtual gift cards expire without being used, reward points will be refunded to the account holder's balance in a number equivalent to the reward points used to redeem the virtual gift card, although an equivalent of a handling fee can optionally be assessed in reward points or other nonfinancial currency as an overhead expense for failing to conduct the qualifying transaction prior to expiration of the virtual gift card. In an example of the present embodiment, virtual gift cards have the same validity period of 30 days after the virtual gift card is issued. In another embodiment, each virtual gift card may have a different validity period and/or a virtual gift card may have an expiration date that is independent of issue date, such as virtual gift cards that expire on January 5, regardless of when the virtual gift card was issued.

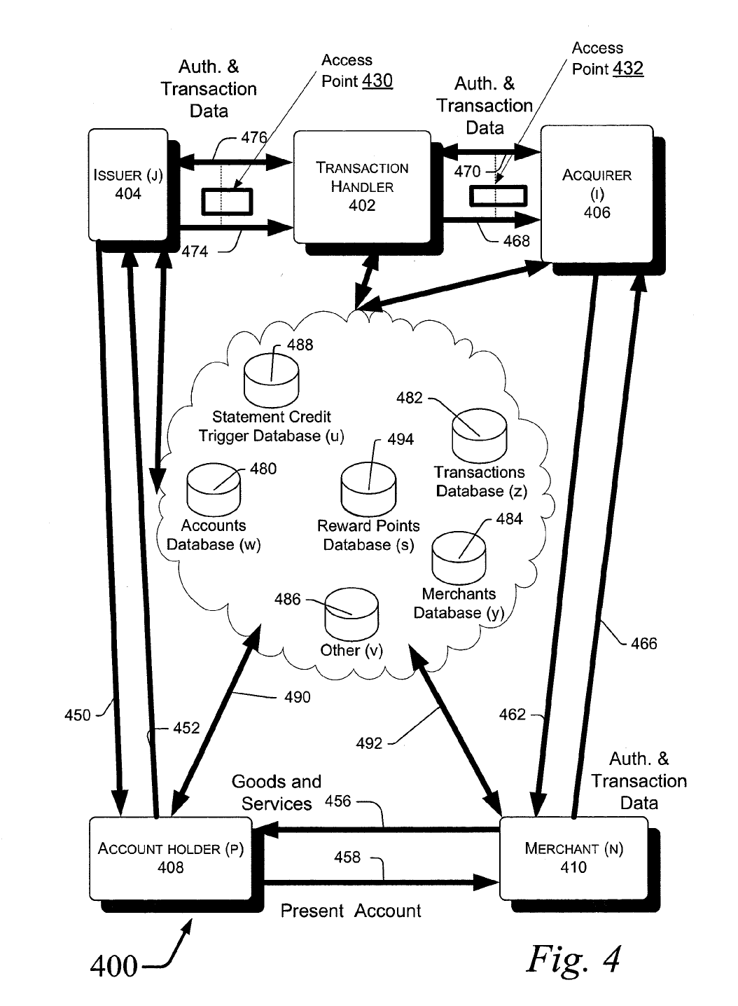

Referring to FIG. 4, an Account holder (p) 408 conducts a financial transaction with a Merchant (m) 410. By way of example, the financial transaction with the merchant may have been made in conjunction with a virtual gift card.

The diagram of FIG. 4 depicts an exemplary process 400 of a particular financial transaction system. By way of explanation for the nomenclature of reference numerals used in the Figures and described in the specification, a lower case letter in parenthesis is intended to mean an integer variable having a value from 10 to the capital case of the lower case letter, which value can be large (i.e., approaching infinity). Thus ‘(b)’ is intended to mean that the integer ‘b’ can have a value from 1 to B, and ‘c’ is intended to mean that the integer ‘c’ can have a value from 1 to C, etc. As such, drawing elements 404, 406, 408, 410, 480, 482, 484, 486, 488, and 494 in FIG. 4 are illustrated with a block, but indicate one or more elements can be present. For example, Issuer (j) 404 is one of a possible plurality of issuers, where ‘j’ may range from 1 to a large integer.

Account holder (p) 408 redeems a sufficient number of reward points for a virtual gift card. Account holder may redeem the reward points using any number of Internet connected devices. Once the reward points are redeemed, a statement credit trigger is created in the statement credit trigger database (u) 488 and a sufficient number of reward points are deducted from Account Holder's balance in Reward Points Database (s) 494.

After Account holder (p) 408 redeems the virtual gift card, Account holder (p) 408 presents an electronic payment device (i.e.; a credit card) to a Merchant (m) 410 (at step 458) as tender for a qualified financial transaction (i.e. a transaction that satisfies the requirements defined by the virtual gift card, including time and amount). Those of skill in the art will recognize that other financial transactions and instruments other than credit cards may also be used, including, but not limited to, a prepaid card and a debit card. For purposes of illustration and explanation, however, reference will be made to a credit card.

As part of the transaction, the Account holder's 408 payment device can be a credit card, debit card, prepaid card, cellular telephone, Personal Digital Assistant (PDA), etc. The payment device is read by a reader operated by the merchant (m) 410, whereupon account information is read from the payment device and a request for authorization is transmitted to the Merchant's 410 Acquirer (i) 406 (at step 462). Each Acquirer (i) 406 is a financial organization that processes credit card transactions for businesses, for example merchants, and is licensed as a member of a transaction handler 402 such as a credit card association (i.e., Visa Inc., MasterCard, etc.) As such, each Acquirer (i) 406 establishes a financial relationship with one or more Merchants (m) 410.

The Acquirer (i) 406 transmits the account information to the Transaction Handler 402 (at step 470), who in turn routes the request to the account holder's issuing bank, or Issuer (j) 404 (at step 476). The Issuer (j) 404 returns authorization information to the Transaction Handler 402 (at step 474) who returns the information to the Merchant (m) 410 through the Acquirer (i) 406 (by steps 468 and 466). The Merchant (m) 410 now knowing whether the Issuer's (j) 404 credit card account is valid and supports a sufficient credit balance, may complete the transaction and the Account holder (p) 408 in turn receives goods and/or services in exchange (at step 456). Most credit card associations instruct merchants that, after receiving authorization, the detailed credit card account information obtained from the point of sale magnetic stripe scanner is to be deleted.

To reconcile the financial transactions and provide for remuneration, information about the transaction is provided by the Merchant (m) 410 to Acquirer (i) 406 (at step 462), who in turn routes the transaction data to the Transaction Handler 402 (at step 470) who then provides the transaction data to the appropriate Issuer (j) 404 (at step 476). The Issuer (j) 404 then provides funding for the transaction to the Transaction Handler 402 (at step 474) through a settlement bank (not shown). The funds are then forwarded to the Merchant's (n) 410 Acquirer (i) 406 (at step 468) who in turn pays the Merchant (m) 410 for the transaction conducted at step 462 less a merchant discount, if applicable. The Issuer (j) 404, then bills the Account holder (p) 408 (at step 450), and the Account holder (p) 408 pays the Issuer 404 (at step 452), with possible interest or fees.

Each of the Issuer (j) 404, Merchants (m) 410, Acquirer (i) 406 and the Transaction Handler 402 may have access to information resources having one or more of the following databases: transaction database (z) 482, merchant database (y) 484, account database (w) 480, Statement Credit Trigger Database (u) 488, Reward Points Database (s) 494, and/or other database (v) 486. These databases can be connected by a network, Internet, virtual private network, or by other means known to those skilled in the art. Moreover, not every participant necessarily has access to any or all of the databases. Each database can assign read, write, and query permissions as appropriate to the various participants. For example, a Merchant (m) 410 have read access to the account database (w) 480 and the Issuer (j) 404 may have read and write access.

The transaction database (z) 482 is designed to store some or all of the transaction data originating at the Merchants (m) 410 that use a payment device for each transaction conducted between an Account holder (p) 408 and the Merchant (m) 410. The transaction data can include information associated with the account of an Account holder (p) 408, date, time, and location among other more specific information including the amount of the transaction. The database can be searched using account information, date and time (or within proximity thereof), or by any other field stored in the database.

The Reward Points Database (s) 494 is designed to store the number of earned reward points for each Account holder (p) 408. Reward points are earned for certain qualifying purchases made by the Account Holder. In one embodiment, the Issuer (j) 404 sets the ratio of points earned per dollar spent. For example, an in-store credit purchase of $100 may earn 100 reward points if the Issuer (j) sets a one-to-one reward point to dollar spent ratio.

The Statement Credit Trigger Database (u) 488 is designed to store statement credit triggers associated with virtual gift cards. A statement credit trigger is created in the Statement Credit Trigger Database (u) 488 when an Account Holder 408 redeems reward points for a virtual gift card. To qualify for a statement credit, the statement credit trigger is created before account holder makes a qualified purchase.

The Merchant database (y) 484 is designed to store information about each Merchant (m) 410. The Merchant database (y) 484 can contain information such as the unique identification of each Merchant (m) 410, an identifier for each point of sale device in use by the Merchant (m) 410, and location of the Merchant (m) 410.

The account database (w) 480 is designed to store account information for payment devices associated with Account holder (p) 408. The account database (w) 480 can store part or all of an account number, unique encryption key, account information, account name. The information from the account database (w) 480 can be associated with information from the transaction database (z) 482.

Account holder's payment device is typically presented at the Point Of Service terminal (POS) at which data thereon is read. Certain transaction information is transmitted from the POS in route to the Merchant's (n) 410 Acquirer (i) 406. The transaction information can include account information, account name, transaction balance, transaction time, transaction date, and transaction location. Sensitive information includes information such account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the Merchant (m) 410, and the ultimate destination, such as the Acquirer (i) 406. These points can include, without limitation, from the reader at the POS, the POS at the Merchant (m) 410 and a network router or computer that is connected to a network but is housed and maintained by the Merchant (m) 410 and between the Merchant (m) 410 and the Acquirer (i) 406. The communication channel could be Ethernet, wireless internet, satellite, infrared transmission, or other known communication protocols. Some or all of the transmission may also be stored for record keeping, archival or data mining purposes with little or no encryption. For example, the Merchant (m) 410 may store transaction data, including certain account information in the Merchant's (n) 410 accounts on file database for reuse later.

In this process, transaction information relating to the qualifying purchase is retrieved from the POS at a Merchant (m) 406. The transaction information is comprised of account information together with other information about the transaction itself: time, date, location, value, etc. Certain of the transaction information is considered sensitive information including, without limitation, account number, credit card verification number, and account name.

Upon completion of the qualifying transaction relating to a valid statement credit trigger, transaction information relating to the statement credit is used to initiate a second transaction that largely mimics the path of the qualifying purchase transaction except in the opposite direction. In one embodiment, the statement credit is a transfer of funds from the Issuer (j) 404 to the Account holder (p) 408. In another embodiment, the statement credit can be funded by any number of interested parties, including the Issuer (j) 404, Merchant (n) 410, or any product manufacturer. In that case, the statement credit trigger is a transfer of funds from one or more interested party to the Account holder (p) 408.

FIG. 4 illustrates a telecommunications network that may make use of any suitable telecommunications network and may involve different hardware, different software and/or different protocols then those discussed below. FIG. 4 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account. Settlement is the process of calculating and determining the net financial position of each member for transactions that are cleared. The actual exchange of funds is a separate process.

Transactions can be authorized, cleared and settled as either a dual message or a single message transaction. A dual message transaction is sent twice—the first time with information needed for an authorization decision, and again later with additional information for clearing and settlement. A single message transaction is sent once for authorization and contains clearing and settlement information as well. Typically, authorization, clearing and settlement occur on-line.

FIG. 4 includes one or more transaction handlers 402, access points 430, 432, acquirers 406, and issuers 404. Other entities such as drawee banks and third party authorizing agents may also connect to the network through an access point. An interchange center is a data processing center that may be located anywhere in the world. In one implementation, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections, such as ones based on an IBM SNA protocol. Preferable, the communication lines that connect an interchange center (Transaction Handler 402) to remote entities use dedicated high-bandwidth telephone circuits or satellite connections based on, for example, the IBM SNA-LUO communication protocol. Messages may be sent over these lines using any suitable implementation of the ISO 8583 standard.

Access points 430, 432 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) and its access point, and between the access point and issuer (i) 404 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to other interchange centers. This linking enables processing centers to communicate with each other through one or more interchange centers. Also, processing centers can access the networks of other programs through the interchange center. Further, the network ensures that links have multiple backups. The connection from one point of the network to another is not usually a fixed link; instead, the interchange center chooses the best possible path at the time of any given transmission. Rerouting around any faulty link occurs automatically.

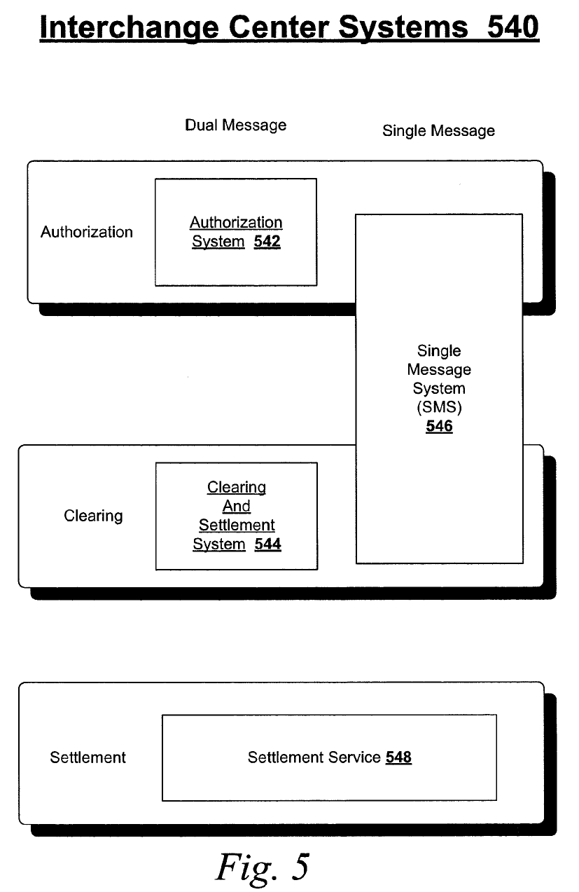

FIG. 5 illustrates systems 540 housed within an interchange center to provide on-line and off-line transaction processing. For dual message transaction, authorization system 542 provides authorization. System 542 supports on-line and off-line functions, and its file includes internal systems tables, a customer database and a merchant central file. The on-line functions of system 542 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 542 to system 546 makes it possible for members using system 542 to communicate with members using system 546 and access the SMS gateways to outside networks.

Clearing and settlement system 544 clears and settles previously authorized dual message transactions. Operating six days a week on a global basis, system 544 collects financial and non-financial information and distributes reports between members. It also calculates fees, charges and settlement totals and produces reports to help with reconciliation. A bridge forms an interchange between system 544 processing centers and system 546 processing centers.

Single message system 546 processes full financial transactions. System 546 can also process dual message authorization and clearing transactions, and communicates with system 542 using a bridge and accesses outside networks as required. System 546 processes Visa, Plus Interlink and other card transactions. The SMS files comprise internal system tables that control system access and processing, and the cardholder database, which contains files of cardholder data used for PIN verification and stand-in processing authorization. System 546 on-line functions perform real-time cardholder transaction processing and exception processing for authorization as well as full financial transactions. System 546 also accumulates reconciliation and settlement totals. System 546 off-line functions process settlement and funds transfer requests and provide settlement and activities reporting. Settlement service 548 consolidates the settlement functions of system 544 and 546, including Interlink, into a single service for products and services. Clearing continues to be performed separately by system 544 and system 546.

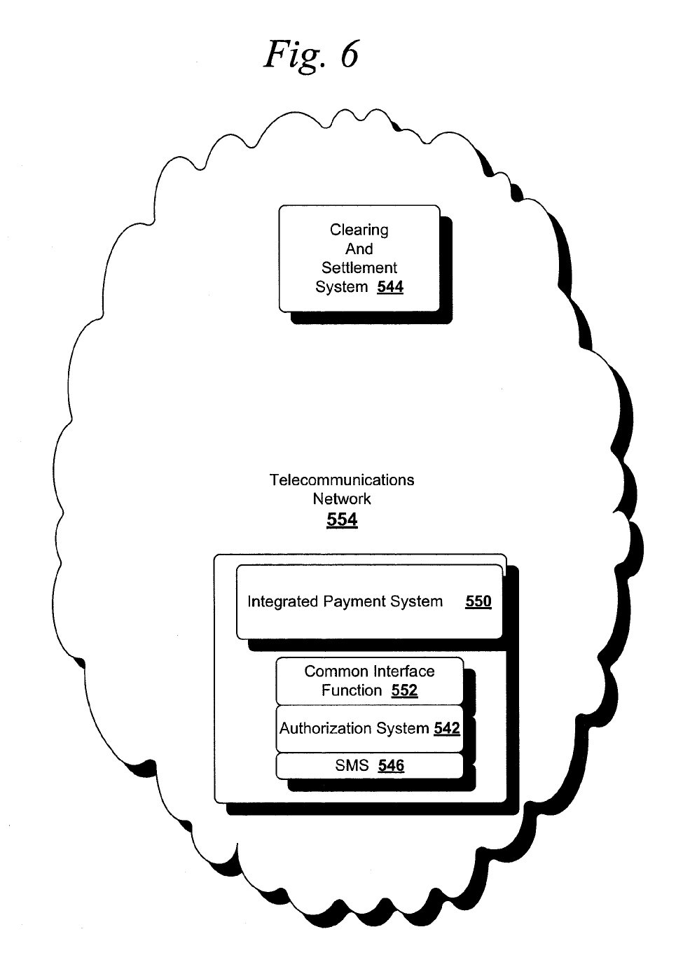

FIG. 6 illustrates another view of components of FIG. 5 as a telecommunications network 554. Integrated payment system 550 is a primary system for processing on-line authorization and financial request transactions. System 550 reports both dual message and single message processing. In both cases, settlement occurs separately. The three main software components are the common interface function 552, authorization system 542 and single message system 546.

Common interface function 552 determines the processing required for each message received at an interchange center. It chooses the appropriate routing, based on the source of the message (system 542, 544 or 546), the type of processing request and the processing network. This component performs initial message editing, and, when necessary, parses the message and ensures that the content complies with basic message construction rules. Common interface function 552 routes messages to their system 542 or system 546 destinations.

The VisaNet® system is an example component of the transaction handler 402 in the payment processing system 400. Presently, the VisaNet® system is operated in part by Visa Inc. As of 2007, the VisaNet® system Inc. was processing around 300 million transaction daily, on over 1 billion accounts used in over 170 countries. Financial institutions numbering over 16,000 connected through the VisaNet® system to around 30 million merchants. In 2007, around 81 billion transactions for about 4 trillion U.S. dollars were cleared and settled through the VisaNet® system, some which involved a communication length of around 24,000 miles in around two (2) seconds.

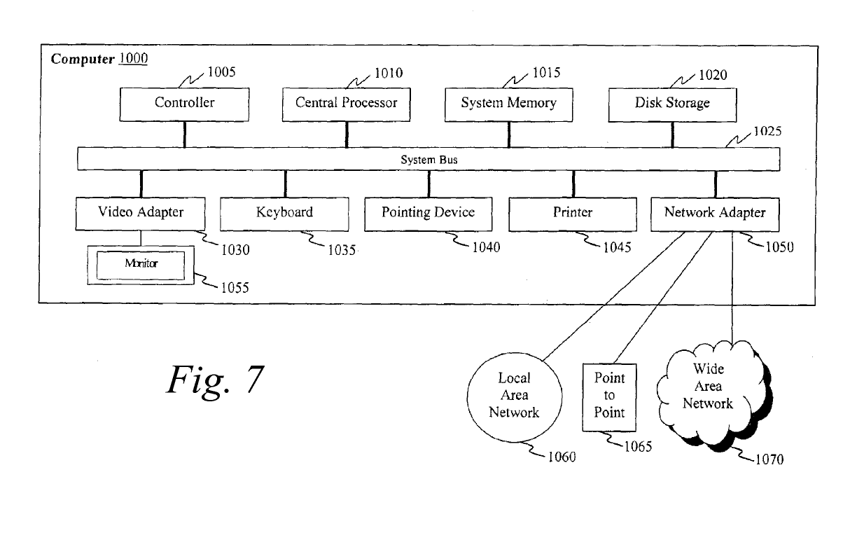

Referring to FIG. 7, a system is shown which includes a digital processing apparatus. This system includes a general-purpose computer 1000, which can be used to implement at least some of the components of a virtual gift card system according to one embodiment. For example, in FIG. 1, transaction handler 108 may comprise one or more computers configured to handle transactions arriving via contacts 154, 160, and/or 162. Furthermore, the transaction handler 108 may comprise one or more transaction processing computers and/or one or more general purpose computers to comprise statement credit processor 116, matching engine 120. and database engines (which could be handling databases 110, 118, and 124). Also in FIG. 1, devices 112, 114, and 122 may be computers with account holder 102 possibly using a computer such as a mobile device (e.g., laptop, notebook, tablet, mobile telephone, or PDA) or a desktop device which would be useful for purchases over a communications or network link.

In FIG. 7, the computer 1000 may include a graphics display, print hardware, and print software, may be as simple as a generic personal computer, desktop computer, laptop computer, or may be configured to perform network transaction processing. The computer may be incorporated into a cellular telephone, personal digital assistant, tablet computer, network enabled television set or any other internet connected device. The example computer in FIG. 7 includes central processor 1010, system memory 1015, optional data storage 1020 (e.g., hard drive, CD-ROM drive, non-volatile memory such as flash memory, or DVD drive), controller 1005, network adapter 1050, video adapter 1030, and monitor 1055. Data input may be through one or more of the following agencies: keyboard 1035, pointing device 1040, disk storage 1020, local area network 1060, point to point communications 1065, and wide area network 1070 (e.g., internet).

One or more features of the computer as shown may be omitted while still permitting the practice of the invention. For example, printer 1045 is not necessary for images (see FIGS. 3(a) and 3(b) for example) intended to be displayed on monitor 1055. Any combination of monitor 1055, keyboard 1035, and pointing device 1040 may be omitted for a computer intended for “backoffice” work. Likewise, local area network 1060, point to point communications 1065, and wide area network 1070 singly or collectively may be employed.

The flow charts herein illustrate the structure of the logic of the present invention as embodied in computer program software. Those skilled in the art will appreciate that the flow charts illustrate the structures of logic elements, such as computer program code elements or electronic logic circuits, that function according to this invention. The invention is practiced by a machine component that renders the logic elements in a form that instruct one or more a digital processing apparatuses (that is, computers) to perform a sequence of function steps corresponding to those shown.

Preferably, the present invention employs a network of general purpose and specialty computers. For example, in FIG. 1, transaction handler 108 may comprise one or more computers configured to handle transactions arriving via contacts 154, 160, and/or 162. Furthermore, the transaction handler 108 may comprise one or more transaction processing computers and/or one or more general purpose computers to comprise statement credit processor 116, matching engine 120. and database engines (which could be handling databases 110, 118, and 124). Also in FIG. 1, devices 112, 114, and 122 may be computers with account holder 102 possibly using a computer such as a mobile device (e.g., laptop, notebook, tablet, mobile telephone, or PDA) or a desktop device which would be useful for purchases over a communications or network link. The process 200 presented in FIG. 2 also may be performed by computer such as a transaction processing device. As described above, display screens associated with process 200, such as screen 300 in FIG. 3(a) and screen 312 in FIG. 3(b), are presented on an account holder's computer display.

The process 400, depicted in FIG. 4, involves a number of computer systems, preferably networked together (although pieces of the system 400 may be connected by other forms of communication links such as point-to-point links). In particular, transaction handler 402 is preferably a transaction processing computer while databases 480, 482, 484, 486, 488, and 494 are managed by one or more computers. The transaction handler 402 comprises the systems of FIG. 5, interchange center systems 540. As discussed above, systems 540 provide on-line and off-line transaction processing for authorization system 542, clearing and settlement system 544, and settlement service 548. As noted for transaction handler 402, systems 540 are preferably composed of one or more transaction processing computers.

FIG. 6 is an alternate view of the components of FIG. 5 shown in a telecommunications network. In this view, the clearing and settlement system 544 and the integrated payment system 550 are part of a telecommunications network 554. Computer software components include common interface function 552, authorization system 542, and single message system 546.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in computer readable medium that can be loaded onto a general purpose computer, a special purpose computer, or other programmable apparatus.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A computer implemented method comprising:
receiving, in a computer apparatus, a request from an account holder to redeem reward points from a non-financial currency account that was issued by an issuer to the account holder, in exchange for a virtual gift card, wherein:
the account holder has a financial currency account issued to the account holder by an issuer; and
the account holder has a balance of reward points in the non-financial currency account;
deducting, by the computer, a predetermined number of reward points from account holder's balance of reward points in the non-financial currency account;
creating, by the computer, a statement credit trigger, wherein the statement credit trigger corresponds to:
a monetary amount; and
the predetermined number of reward points deducted from the nonfinancial currency account;
receiving, in the computer, transaction information, wherein the transaction information contains a qualifying transaction conducted by the account holder with a merchant;
attempting, by the computer, to find a match of the statement credit trigger with the qualifying transaction in the received transaction information, wherein:
if the match is not found:
modifying, by the computer, the statement credit trigger; and
adding, by the computer, the predetermined number of reward points to account holder's balance of reward points in the non-financial currency account; and
if the match is found, crediting, by the computer, the monetary amount of the statement credit trigger to the financial currency of the account holder.

2. The method of claim 1, wherein the qualifying transaction is at least one selected from the group consisting of a transaction with a specific merchant, a transaction of a minimum currency amount, and a transaction completed before an expiration date.

3. The method of claim 1, wherein if the statement credit trigger expires after a specified period or date, the method further comprises:
deleting, by the computer, the statement credit trigger; invalidating, via instructions executed by the computer, the virtual gift card;
invalidating, by the computer, the virtual gift card; and
adding, by the computer, the reward points back to the non-financial currency account minus a handling fee of zero or more reward points.

4. The method of claim 1, wherein the match of the statement credit trigger with the qualifying transaction in the received transaction information is a partial match of the statement credit trigger with the qualifying transaction.

5. The method of claim 1, wherein the modifying the statement credit trigger comprises deleting the statement credit trigger.

6. The method of claim 1, wherein the steps further comprise assessing, by the computer, the monetary amount corresponding to the statement credit trigger to an entity, wherein:
the qualifying transaction conducted by the account holder with the merchant was for an item distributed to the merchant by a distributor and manufactured by a manufacturer; and
the entity is selected from the group consisting of the merchant, the manufacturer, the distributor, and any combination of the foregoing.

7. The method of claim 6, further comprising, prior to the receiving of the request, sending, via instructions executed by the computer, to an address corresponding to the account holder an offer for the virtual gift card for conducting the qualifying transaction with the merchant to purchase the item distributed to the merchant by the distributor that was manufactured by the manufacturer.

8. An apparatus comprising:
memory coupled to a processing module having stored thereon a set of instructions, which when executed cause at least one processor to:
receive transaction information, wherein the transaction information contains a qualifying transaction conducted by an account holder with a merchant; and
attempt to find a match of a statement credit trigger with the qualifying transaction in the received transaction information, wherein:
if the match is not found:
modify the statement credit trigger; and
add a predetermined number of reward points to a balance of reward points of the account holder in a non-financial currency account; and
if the match is found, credit a monetary amount of the statement credit trigger to a financial currency account of the account holder.

9. The apparatus of claim 8, further comprising:
the at least one processor coupled with the memory.

10. The apparatus of claim 8, further comprising, prior to receiving transaction information:
receiving a request from the account holder to redeem reward points from the non-financial currency account that was issued by an issuer to the account holder, in exchange for a virtual gift card;
deducting the predetermined number of reward points from the balance of reward points of the account holder in the non-financial currency account;
creating a statement credit trigger; and
deducting the predetermined number of reward points from the non-financial currency account.

11. The apparatus of claim 8, wherein the match of the statement credit trigger with the qualifying transaction in the received transaction information is a partial match of the statement credit trigger with the qualifying transaction.

12. The apparatus of claim 8, wherein the modifying the statement credit trigger comprises deleting the statement credit trigger.

13. The apparatus of claim 8, wherein the qualifying transaction is at least one selected from the group consisting of a transaction with a specific merchant, a transaction of a minimum currency amount, and a transaction completed before an expiration date.

14. The apparatus of claim 8, wherein the set of instructions, if the statement credit trigger expires after a specified period or date, further comprises:
deleting the statement credit trigger;
invalidating the virtual gift card; and
adding the reward points back to the non-financial currency account minus a handling fee of zero or more reward points.

15. The apparatus of claim 8, wherein the set of instructions further comprises assessing the monetary amount corresponding to the statement credit trigger to an entity, wherein:
the qualifying transaction conducted by the account holder with the merchant was for an item distributed to the merchant by a distributor and manufactured by a manufacturer; and
the entity is selected from the group consisting of the merchant, the manufacturer, the distributor, and any combination of the foregoing.

16. The apparatus of claim 13, wherein, prior to the receiving of the request, the set of instructions further comprises sending to an address corresponding to the account holder an offer for the virtual gift card for conducting the qualifying transaction with the merchant to purchase the item distributed to the merchant by the distributor that was manufactured by the manufacturer.

17. A computer implemented method comprising:
sending, via a computer, to an account holder notification of available redemption options for accumulated reward points;
receiving, by the computer, a request from the account holder to redeem specified reward points from a non-financial currency account;
generating by the computer, a statement credit trigger in response to the request, the statement credit trigger being associated with an amount of statement credit corresponding to the specified reward points and a predetermined expiration date; and
converting, by the computer, the amount of statement credit associated with the statement credit trigger back to reward points in the nonfinancial currency account upon the predetermined expiration date.

18. The method of claim 17, further comprising notifying, by the computer, the account holder of one or more merchants in a specified location associated with the statement credit trigger.
